(19) United States
(12) Patent Application Publication
(10) Pub. No.: US 2009/0078042 A1
(43) Pub. Date: Mar. 26, 2009

(54) FLUID FLOW SENSOR

(76) Inventor: Joel Haynes, Tarzana, CA (US)

Correspondence Address: John Alumit, 16830 Ventura Blvd. Suite 360, Encino, CA, 91436, US

(21) Appl. No.: 12/211,802

(22) Filed: Sep. 16, 2008

Related U.S. Application Data
(60) Provisional application No. 60/994,351, filed on Sep. 17, 2007.

(51) Int. Cl. G01F 3/02

(52) U.S. Cl. 73/232

(57) ABSTRACT

An improved fluid flow sensor comprising a housing with a fluid inlet and fluid outlet, a valve chamber connected to the fluid inlet, and a movable valve body wherein the valve body moves between a first position, blocking a first outlet in the valve chamber, and a second position blocking a second outlet in the valve chamber; the first outlet of the valve chamber connected to an inlet at the first end of a measuring chamber, and the second outlet of the valve chamber connected to an inlet at the second end of the measuring chamber, with a movable measuring body located in the measuring chamber capable of moving between the first and second ends of the measuring chamber, and the measuring chamber having outlets at the first and second ends, so that the movable bodies switch position in tandem as fluid flows through the system.

### CROSS-REFERENCE TO RELATED APPLICATION

This application claims the benefit of the priority date of provisional application No. 60/994,351, filed on Sep. 17, 2007

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates to flow sensors, and more particularly to flow sensors capable of passing suspended particulate matter through the sensor while measuring the flow of fluids with large variations in viscosity.

Flow sensors are known in the art. U.S. Pat. No. 4,635,476 to Haynes discloses a fluid flow sensor wherein two movable bodies in a valve chamber and measuring chamber move from one side of each chamber to the other in tandem with the movement of a specified quantity of fluid.

U.S. Pat. No. 4,802,362 to Haynes discloses a fluid flow sensor wherein two movable bodies in a valve chamber and measuring chamber move from one side of each chamber to the other in tandem with the movement of a specified quantity of fluid.

Although the above cited references are capable of measuring fluids with little or no particulate matter suspended therein, or fluids of low viscosity, when fluids with high viscosity or a high particulate concentration are introduced, particulates within the fluid form accretions near the entrances and exits to the chambers, eventually causing sensor to fail.

It is therefore an object of the present invention to provide a fluid flow sensor capable of accurately measuring fluids of a wide range of viscosity. Another object of the invention is to provide a fluid flow sensor capable of driving particulates forward or backward in the flow stream as a body in the sensor comes into contact with an inlet or outlet port in the sensor. Another object of the invention is to provide a means of dividing particulates that become lodged at the contact point of a body and an inlet and outlet port through the striking action of the body against the port. These and other objects will become apparent from the appended summary, description and claims.

### SUMMARY

In a preferred embodiment of the flow sensor, the sensor comprises a housing with a top fluid inlet and a bottom fluid outlet. Fluid flows through the housing through a series of channels, alternating the position of movable bodies therein. Specifically, an inlet valve directs the flow of fluid to a first outlet or second outlet in the inlet valve and is connected to the fluid inlet. A movable valve body in the inlet valve is movable between a first position closing the first outlet, and a second position closing the second outlet.

When the movable valve body is blocking the first outlet, fluid flows through the inlet valve, past the movable valve body and through the second outlet. When the movable valve body is blocking the second outlet, fluid flows through the inlet valve, past the movable valve body and through the first outlet. Typically, the movable valve body comprises a spherical shape.

The first and second outlets of the inlet valve means lead to a measuring chamber. The first outlet of the inlet valve means connects to the first end of the measuring chamber, and the second outlet of the inlet valve means connects to the second end of the measuring chamber. The measuring chamber also has an outlet at the first end of the measuring chamber, and an outlet at the second end of the measuring chamber.

A movable measuring body in the measuring chamber is movable between the first end and second end of the chamber. The movable measuring body occupies the circumference of the measuring chamber so that fluid remains on one side of the movable measuring body or the other. Typically, the movable measuring body is also spherical.

When the movable measuring body is at the first end of the measuring chamber, it simultaneously closes off the connection to the first outlet of the inlet valve means and the first outlet of the measuring chamber. When the movable measuring body occupies the second end of the measuring chamber, it simultaneously closes off the connection to the second outlet of the inlet valve means and second outlet of the measuring chamber.

The first end and second end of the measuring chamber also comprise inlet and outlet ports configured so that the movable measuring body seals both ports simultaneously and creates a decreased cross-sectional area at the point of contact. By creating a contact point of decreased cross-sectional area, particulates suspended in the flow stream are directed to either the upstream or downstream side of the contact points. A particulate caught at the contact point will be divided by the striking action of the movable measuring body against the inlet and outlet ports. The contact point may also comprise a generally sharpened profile wherein the movable measuring body strikes ports at the apex of the sharpened profile.

The ports at the first and second end of the measuring chamber further comprise nested ports constructed so that a ring shaped outlet port surrounds a recessed inlet port, and wherein the outlet port has a larger opening area than the inlet port so that the force exerted on the moveable measuring body by the downstream pressure from the outlet port is sufficient to hold it in position against the upstream pressure from the inlet port.

In another preferred embodiment, each outlet port has an opening in the side wall connecting to a channel leading to the fluid outlet, and each inlet port is connected to the valve chamber by a channel disposed through the center of the outlet port.

As fluid moves through the sensor, it flows past the movable valve body in the inlet valve means with the movable valve body in the first position, causing fluid to flow through the second outlet. Fluid flowing through the second outlet flows into the second end of the measuring chamber, urging the movable measuring body toward the first end of the measuring chamber. During this process, the movable valve body is held in the first position solely by combined upstream pressure at the fluid inlet and downstream pressure at the measuring chamber.

When the movable measuring body reaches the first end of the measuring chamber, it closes off the first end, causing the movable valve body to be released from the first valve outlet and travel to the second position, blocking the second valve. When this happens, fluid flows from the first valve outlet into the first end of the measuring chamber, urging the movable measuring body toward the second end of the measuring chamber. During this process the movable valve body is held in the second position solely by combined upstream pressure at the fluid inlet and downstream pressure at the measuring chamber.

In a second embodiment, the valve is disposed downstream from the measuring chamber. This embodiment comprises a housing having a fluid inlet and outlet. The fluid inlet is connected to a measuring chamber, wherein each end of the measuring chamber is separately connected to the fluid inlet. Also, the first end of the measuring chamber is connected to a first outlet, and the second end of the measuring chamber is connected to a second outlet.

A movable measuring body is movable between the first and second ends of the measuring chamber. When the movable measuring body is at the first end of the chamber, it blocks the first outlet of the measuring chamber. When the movable measuring body is at the second end of the chamber, it blocks the second outlet of the measuring chamber.

A valve chamber located downstream from the measuring chamber comprises a first inlet connected to the first outlet of the measuring chamber, and a second inlet connected to the second outlet of the measuring chamber. The valve chamber further comprises an outlet associated with the first inlet, and an outlet associated with the second inlet, both of which are connected to the fluid outlet. A movable valve body in the valve chamber moves between a first position that seals the first inlet and outlet, and a second position sealing the second inlet and outlet.

The first inlet and outlet and the second inlet and second outlet of the valve chamber further comprises ports. These ports are configured so that the movable valve body seals both an inlet and an outlet simultaneously, creating a decreased cross-sectional area at the point of contact between the movable body and the ports. Particulates suspended in the flow stream are directed to the upstream or downstream side of the contact point. If a particulate catches at the point of contact, it is divided by the striking action of the movable valve body against the contact point. In an alternate embodiment, the point of contact may comprise a generally sharpened profile wherein the movable valve body strikes the ports at the apex of the sharpened profile.

The ports at each end of the valve chamber further comprise nested ports, constructed so that the outlet port is ring shaped and surrounds the inlet port, which is recessed into the outlet port, and wherein the outlet port has a larger opening area than the inlet port, so that when the moveable valve body covers the ports, the force exerted on the moveable valve body by the downstream pressure from the outlet port is sufficient to hold it in position against upstream pressure from the inlet port. In another embodiment, the outlet ports are connected to the fluid outlet through a channel, the entrance of which is disposed in the side wall of the outlet ports, and each inlet port is connected to the measuring chamber by a channel, the entrance of which is disposed through the ring of its associated outlet port.

As fluid moves through the sensor, when the movable valve body is in the first position, blocking the first inlet and outlet port, fluid flows from the fluid inlet into the measuring chamber, causing the movable measuring body to move toward the second end of the measuring chamber.

When the movable measuring body reaches the second end of the measuring chamber, it closes the second outlet of the chamber, causing fluid to push the movable valve body into the second position, blocking the second inlet and outlet. As this happens, fluid flowing into the second end of the measuring chamber urges the movable measuring body toward the first end of the chamber. When the movable measuring body reaches the first end of the measuring chamber, the first outlet of the measuring chamber is blocked, causing the movable valve body to return to the first position, and urge the movable measuring body once again toward the second end of the measuring chamber.

In a third embodiment of the invention, both the measuring chamber and valve chamber have nested ports, and a switching chamber is disposed upstream from the measuring chamber. This embodiment comprises a housing with a fluid inlet and outlet, and a switching chamber connected to the fluid inlet comprising a first end and a second end. A first outlet is associated with the first end and a second outlet is associated with the second end. A first movable body is located in the switching chamber, capable of moving between the first end and second end, and when disposed at the first end, blocks the first outlet; when disposed at the second end, the first movable body blocks the second outlet.

A measuring chamber is connected to the first second outlets of the switching chamber at the first and second ends of the measuring chamber, respectively, downstream from the switching chamber. The measuring chamber also has a first fluid outlet at the first end of the measuring chamber, and a second fluid outlet at the second end of the measuring chamber.

A movable measuring body in the measuring chamber moves between the first and second end. When the movable measuring body is at the first end, it blocks the first inlet and outlet of the measuring chamber. When the movable measuring body is at the second end of the measuring chamber, it blocks the second inlet and outlet of the measuring chamber.

The first and second ends of the measuring chamber also comprise inlet and outlet ports that provide a decreased cross-sectional area at the contact point of the movable measuring body and the ports so that particulates are directed to either the upstream or downstream side of the contact point, or are divided by the striking action of the movable measuring body against the contact point. In addition, the contact point can comprise a generally sharpened profile at the contact point wherein the movable measuring body strikes the ports at the apex of the sharpened profile.

In a further preferred embodiment, the inlet and outlet ports of the measuring chamber further comprise nested ports, in the sense that the outlet port is ring shaped and surrounds the inlet port, and the outlet port has a larger opening area than the inlet port so that the force exerted on the moveable measuring body by downstream pressure from the outlet port it in position against the upstream pressure from the inlet port.

Downstream from the measuring chamber, a valve chamber has a first inlet connected to the first outlet of the measuring chamber, and a second inlet connected to the second outlet of the measuring chamber. The valve chamber also has a first outlet associated with the first inlet and a second outlet associated with the second inlet, wherein both are connected to the fluid outlet.

A movable valve body within the valve chamber is movable between a first position that seals the first inlet and outlet, and a second position that simultaneously seals the second inlet and outlet. The inlet and outlet ports are configured to provide a decreased cross-sectional area at the contact point of the movable valve body and the ports. Particulates are directed to either the upstream or downstream side of the contact point, or are divided by the striking action of the movable valve body against the ports. The contact point of the inlet and outlet ports and movable valve body may also comprise a generally sharpened profile at the contact point, wherein the movable valve body strikes the ports at the apex of the sharpened profile.

In a further embodiment, each inlet and outlet port further comprises nested ports; constructed so that the outlet port is ring shaped and surrounds the inlet port, which is recessed in the outlet port, and wherein the outlet port has a larger opening area than the inlet port, so that when the moveable valve body covers the inlet port and outlet port, the force exerted on it by the downstream pressure from the outlet port is sufficient to hold it in position against the upstream pressure from the inlet port.

In another preferred embodiment, the outlet of the first end of the measuring chamber is connected to the first position inlet port of the valve chamber through a channel disposed in a wall of the outlet port of the first end of the measuring chamber, and the outlet of the second end of the measuring chamber is connected to the second position inlet port of the valve chamber through a channel disposed in a wall of the outlet port of the second end of the measuring chamber.

In another embodiment, an inlet port connecting the first outlet of the switching chamber to the first end of the measuring chamber is disposed through the ring of the outlet port of the first end of the measuring chamber, and an inlet port connecting the second outlet of the switching chamber to the second end of the measuring chamber is disposed through the ring of the outlet port of the second end of the measuring chamber.

In yet another embodiment, the outlet of the first position of the valve chamber is connected to the fluid outlet through a channel disposed in a wall of the outlet port of the first position of the valve chamber, and the outlet of the second position of the valve chamber is connected to the fluid outlet through a channel disposed in a wall of the outlet port of the second position of the valve chamber. In this embodiment the inlet port connecting the first outlet of the measuring chamber to the first position of the valve chamber is disposed through the ring of the outlet port of the first position of the valve chamber, and an inlet port connecting the second outlet of the measuring chamber to the second position of the valve chamber is disposed through the ring of the outlet port of the second position of the valve chamber.

As fluid moves through the sensor, when the movable valve body in the valve chamber seals the first inlet and outlet in the first position, fluid flowing through the sensor urges the movable measuring body in the measuring chamber from the first end of the measuring chamber to the second end of the measuring chamber. When the movable measuring body reaches the second end of the measuring chamber, it cuts off the flow of fluid through the second outlet of the measuring chamber, diverting the fluid through the first outlet of the measuring chamber, and pushing the movable valve body in the valve chamber into the second position.

When the movable valve body reaches the second position, it seals the second fluid inlet and outlet of the valve chamber, and urges the movable measuring body from the second end of the measuring chamber back to the first end of the measuring chamber where it blocks the first outlet of the measuring chamber, diverting fluid through the second outlet of the measuring chamber and causing the movable valve body to switch back to the first position and seal the first inlet and outlet. This causes fluid to urge the movable measuring body toward the second end of the measuring chamber, repeating the process.

In addition, when the first movable body in the switching chamber is in the first end of the switching chamber blocking the first outlet of the switching chamber, the movable measuring body moves from the second end of the measuring chamber toward the first end of the measuring chamber. When the movable measuring body blocks the first outlet of the switching chamber, fluid pressure causes the first movable body to move to the second end of the switching chamber.

When the movable measuring body moves to the second end of the measuring chamber and blocks the second fluid outlet of the switching chamber, the first movable body is urged back to the first end of the switching chamber, repeating the process. In this manner the movement of the first movable body, movable measuring body and movable valve body are synchronized.

In another preferred embodiment of any of the above embodiments of the invention, the movable body can be is a cylinder, and the nested inlet and outlet ports flush to conform to the ends of the cylinder. Each side of a chamber with ports comprises a nested inlet port and outlet port, constructed so that the outlet port is ring shaped and surrounds the inlet port, and wherein the outlet port has a larger opening area than the inlet port, so that when a moveable body covers the inlet port and outlet port, the force exerted upon the body by the downstream pressure from the outlet port is sufficient to hold the moveable body in position against the upstream pressure from the inlet port.

The openings to the outlet port and inlet port conform to the top or bottom surface of the cylindrical body, including a flat surface. The edges of the openings of the outlet port and inlet port may also comprise raised generally sharpened areas so that particulates are directed to either the upstream or downstream side of the contact point of the ports and movable body, or divided by the striking action of the movable body against the apex of the sharpened areas.

### BRIEF DESCRIPTION OF THE FIGURES

FIG. 1 is a perspective view of one embodiment of the flow sensor of the present invention.

FIG. 2 is a front view of a second embodiment of the flow sensor of the present invention.

FIG. 3 is a front view of a third embodiment of the flow sensor of the present invention.

FIG. 4 is a close up perspective view of a movable body and port of the present invention, wherein the movable body is a cylinder.

### DESCRIPTION

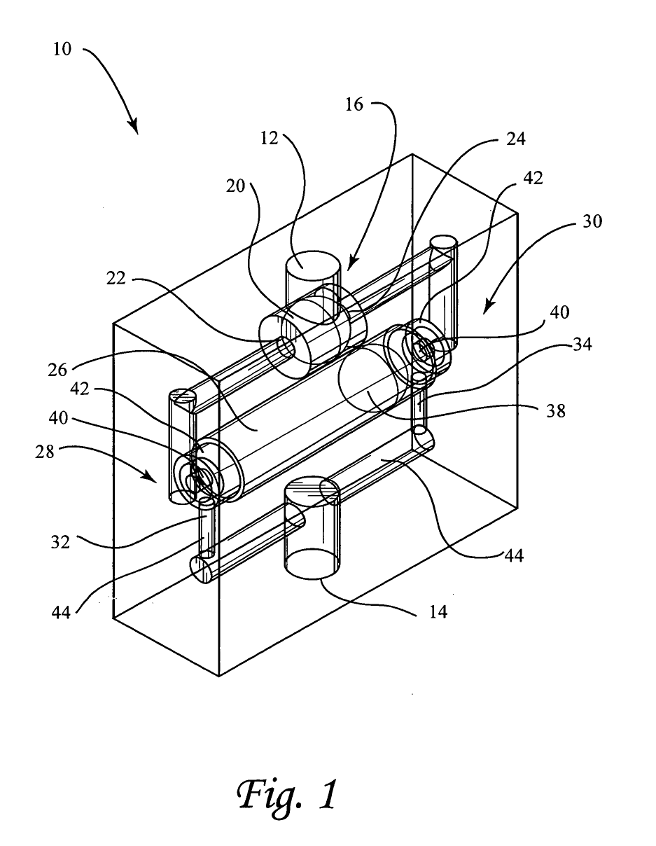

Referring to FIG. 1, a preferred embodiment of an improved fluid flow sensor for measuring the volumetric flow of a fluid is shown and described. The flow sensor comprises a housing 10 with a fluid inlet 12 at its top, and a fluid outlet 14 at its bottom. Fluid flows through the housing 10 through a series of channels, alternating the position of movable bodies therein.

An inlet valve means 16 for directing a continuous flow of fluid from the fluid inlet 12 to a first outlet 22 or a second outlet 24 in the inlet valve means 16 is connected to the fluid inlet 12. The inlet valve means 16 causes fluid to flow through either the first outlet 22 or the second outlet 24, but not both simultaneously. A movable valve body 20 within the inlet valve means 16, is movable between a first position in which the first outlet 22 of the inlet valve means 16 is closed and the second outlet 24 of the inlet valve means 16 is open, and a second position in which the second outlet 24 of the inlet valve means 16 is closed and the first outlet 22 is open.

When the movable valve body 20 is in the first position, blocking the first outlet 22, fluid flows from the inlet 12, through the inlet valve means 16, past the movable valve body 20 and through the second outlet 24 of the inlet valve means 16. When the movable valve body 20 is in the second position, blocking the second outlet 24, fluid flows into the inlet 12, through the inlet valve means 16, past the movable valve body 20 and through the first outlet of the inlet valve means 16. In a preferred embodiment, the movable valve body 20 comprises a spherical shape.

The first 22 and second 24 outlets of the inlet valve means 16 are connected to a measuring chamber 26 having a first end 28 and a second end 30. The first outlet 22 of the inlet valve means 16 connects to the first end 28 of the measuring chamber 26, and the second outlet 24 of the inlet valve means 16 connects to the second end 30 of the measuring chamber 26. The measuring chamber also comprises a first measuring chamber outlet 32 at the first end 28 of the measuring chamber 26, and a second measuring chamber outlet 34 at the second end 30 of the measuring chamber 26.

A movable measuring body 38 is contained within the measuring chamber 26, and is movable between the first end 28 and second end 30 of the measuring chamber 26. The movable measuring body 38 occupies the circumference of the measuring chamber 26, to prevent fluid from crossing from one side of the movable measuring body 38 to the other. In one preferred embodiment, the movable measuring body 38 is a sphere.

When the movable measuring body 38 occupies the first end 28 of the measuring chamber 26, it simultaneously closes off the connection of the first outlet 22 of the inlet valve means 16 to the measuring chamber 26, and the first outlet 32 of the measuring chamber 26. When the movable measuring body 38 occupies the second end 30 of the measuring chamber 26, it simultaneously closes off the connection of the second outlet 24 of the inlet valve means 16 to the measuring chamber 26, and second outlet 34 of the measuring chamber 26.

The first end 28 and second end 30 of the measuring chamber 26 each comprise an inlet port 40 and an outlet port 42. The inlet ports 40 and outlet ports 42 are configured so that the movable measuring body 38 seals both ports simultaneously, and creates a decreased cross-sectional area at the contact point of the movable measuring body 38 and the inlet 40 and outlet ports 42.

By creating a contact point of decreased cross-sectional area, particulates suspended in the flow stream traveling through the housing 10, including maximum sized particulates within the fluid, are directed to either the upstream or downstream side of the contact points of the movable measuring body 38 and the inlet 40 and outlet ports 42.

In the unlikely event that a particulate is caught at the contact point of the movable measuring body 38 and inlet 40 and outlet ports 42, it will be divided by the striking action of the movable measuring body 38 against the contact point of the inlet 40 and outlet ports 42. In addition to the naturally reduced contact point of the movable measuring body 38 and inlet ports 40 and outlet ports 42, in an alternate embodiment, the point of contact point may comprise a generally sharpened profile at the junction of the inlet 40 and outlet 42 ports and movable measuring body 38, wherein the movable measuring body 38 strikes the inlet 40 and outlet 42 ports at the apex of the sharpened profile.

Still referring to FIG. 1, the inlet port 40 and outlet port 42 of the first end 28 and second end 30 of the measuring chamber 26 further comprise an inlet port 40 nested within an outlet port 42. In this manner, the nested ports are constructed so that the outlet port 42 is ring shaped and surrounds the inlet port 40, which is recessed into the outlet port 42, and wherein the outlet port 42 has a larger opening area than the inlet port 40, so that when the moveable measuring body 38 covers the inlet port 40 and outlet port 42, the force exerted on the moveable measuring body 38 by the downstream pressure from the outlet port 42 is sufficient to hold the moveable measuring body 38 in position against the upstream pressure from the inlet port 40.

In another preferred embodiment, each outlet port 42 of the measuring chamber 26 is connected to the fluid outlet 14 through a channel 44, the opening of which is disposed in a side wall of the outlet port 42, and wherein the inlet port 40 is connected to the measuring chamber 26 by a channel disposed through the middle of the outlet port 42.

As fluid moves through the sensor, it moves past the movable valve body 20 in the inlet valve means 16 when the movable valve body 20 is in the first position, causing fluid to flow through the second outlet 24 of the inlet valve means 16. Fluid flowing through the second outlet 24 of the inlet valve means 16 flows into the second end 30 of the measuring chamber 26, urging the movable measuring body 38 toward the first end 28 of the measuring chamber 26. During this process, the movable valve body 20 is held in the first position solely by combined upstream pressure at the fluid inlet 12 and downstream pressure at the first outlet 32 of the measuring chamber 26.

Once the movable measuring body 38 reaches the first end 28 of the measuring chamber 26, it closes off the inlet port 40 of the first end 28 of the measuring chamber 26, causing the movable valve body 20 to be released from the first outlet 22 of the inlet valve means 16, wherein the movable valve body 20 travels to the second position, blocking the second outlet 24 of the inlet valve means 16. When this happens, fluid flows from the first outlet 22 of the inlet valve means 16 into the first end 28 of the measuring chamber 26, urging the movable measuring body 38 toward the second end 30 of the measuring chamber 26. During this process the movable valve body 20 is held in the second position solely by combined upstream pressure at the fluid inlet 12 and downstream pressure at the second outlet 34 of the measuring chamber 26.

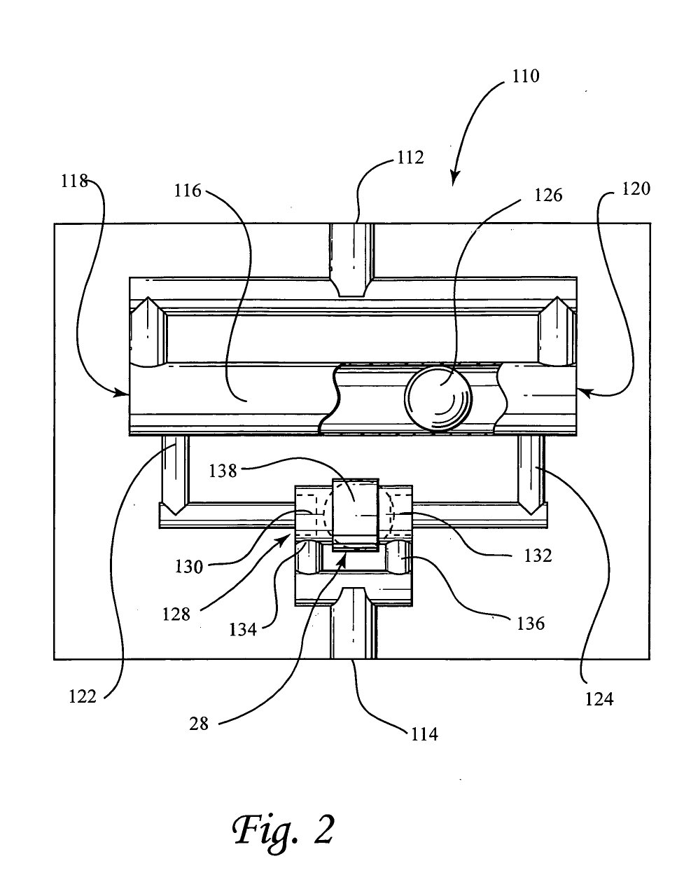

Referring to FIG. 2, an alternate embodiment of the invention is shown and described, wherein the valve is disposed downstream from the measuring chamber. This embodiment comprises a housing 110 having a fluid inlet 112 and a fluid outlet 114. The fluid inlet 112 is connected to a measuring chamber 116 having a first end 118 and a second end 120. Each end of the measuring chamber 116 is separately connected to the fluid inlet 112. The first end 118 of the measuring chamber 116 is connected to a first fluid outlet 122 located at the first end 118 of the measuring chamber 116. The second end 120 of the measuring chamber 116 is connected to a second fluid outlet 124 located at the second end 120 of the measuring chamber 116.

A movable measuring body 126 is located within the measuring chamber 116, and is movable between the first end 118 and second end 120 of the measuring chamber 116. When the movable measuring body 126 is positioned at the first end 118 of the measuring chamber 116, it blocks the first fluid outlet 122 of the measuring chamber 116 and connection to the fluid inlet 112, and when the movable measuring body 126 is positioned at the second end 120 of the measuring chamber 116, it blocks the second fluid outlet 124 of the measuring chamber 116 and connection to the fluid inlet 112.

A valve chamber 128 is located downstream from the measuring chamber 116, and comprises a first inlet 130 connected to the first outlet 122 of the measuring chamber 116, and a second inlet 132 connected to the second outlet 124 of the measuring chamber 116. The valve chamber 128 further comprises a first outlet 134 associated with the first inlet 130 of the valve chamber 128 connected to the fluid outlet 114, and a second outlet 136 associated with the second inlet 132 of the valve chamber 128 connected to the fluid outlet 114.

A movable valve body 138 within the valve chamber 128 is movable between a first position wherein the first inlet 130 and first outlet 134 of the valve chamber 128 are sealed, and a second position wherein the second inlet 132 and second outlet 136 of the valve chamber 128 are sealed.

The first inlet 130 and first outlet 134 of the valve chamber 128, and the second inlet 132 and second outlet 136 of the valve chamber 128 further comprise ports. The inlet and outlet ports are configured so that the movable valve body 138 seals an inlet and outlet port simultaneously, and creates a decreased cross-sectional area at the point of contact between the movable body 138 and the inlet and outlet ports.

By creating a contact point of decreased cross-sectional area, particulates suspended in the flow stream traveling through the housing 110, including maximum sized particulates within the fluid, are directed to either the upstream or downstream side of the contact points of the movable valve body 138 and inlet and outlet ports.

If a particulate happens to catch at the point of contact between the movable valve body 138 and inlet and outlet ports, it will be divided by the striking action of the movable valve body 138 against the contact point. In an alternate embodiment, the point of contact between the inlet and outlet ports and the movable valve body 138 may comprise a generally sharpened profile at the junction of the movable valve body 138 and inlet and outlet ports, wherein the movable valve body 138 strikes the inlet and outlet ports at the apex of the sharpened profile.

Still referring to FIG. 2, the inlet and outlet ports at each end of the valve chamber 128 further comprise an inlet port nested within an outlet port. The nested ports are constructed so that the outlet port is ring shaped and surrounds the inlet port, which is recessed into the outlet port, and wherein the outlet port has a larger opening area than the inlet port, so that when the moveable valve body 138 covers the inlet port and outlet port, the force exerted upon the moveable valve body 138 by the downstream pressure from the outlet port is sufficient to hold the moveable valve body 138 in position against the upstream pressure from the inlet port.

In another preferred embodiment, the outlets 134 and 136 are connected to the fluid outlet 114 through channels, the entrances of which are disposed in the side wall of the outlet ports, and wherein each inlet 130 and 132 is connected to the measuring chamber 116 by a channel, the entrance of which is disposed through the ring of its associated outlet port.

As fluid moves through the sensor, when the movable valve body 138 is in the first position, wherein the first fluid inlet 130 and first fluid outlet 134 are blocked, fluid flows from the fluid inlet 112 into the first end 118 and second end 120 of the measuring chamber 116. Since the first fluid inlet 130 to the valve chamber 128 is blocked, fluid flowing into the measuring chamber 116 causes the movable measuring body 126 to move toward the second end 120 of the measuring chamber 116.

When the movable measuring body 126 reaches the second end 120 of the measuring chamber 116, it closes the second outlet 124 of the measuring chamber 116, causing the fluid to push the movable valve body 138 into the second position, wherein the second fluid inlet 132 and second fluid outlet 136 are blocked. As this happens, fluid flowing into the second end 120 of the measuring chamber 116 urges the movable measuring body 126 toward the first end 118 of the measuring chamber 116.

When the movable measuring body 126 reaches the first end 118 of the measuring chamber 116, the first outlet 122 of the measuring chamber 116 is blocked, causing fluid to flow through the second outlet 124 of the measuring chamber 116, causing the movable valve body 138 to return to the first position, and thereafter causing the movable measuring body 126 to travel once again toward the second end 120 of the measuring chamber 116, repeating the process.

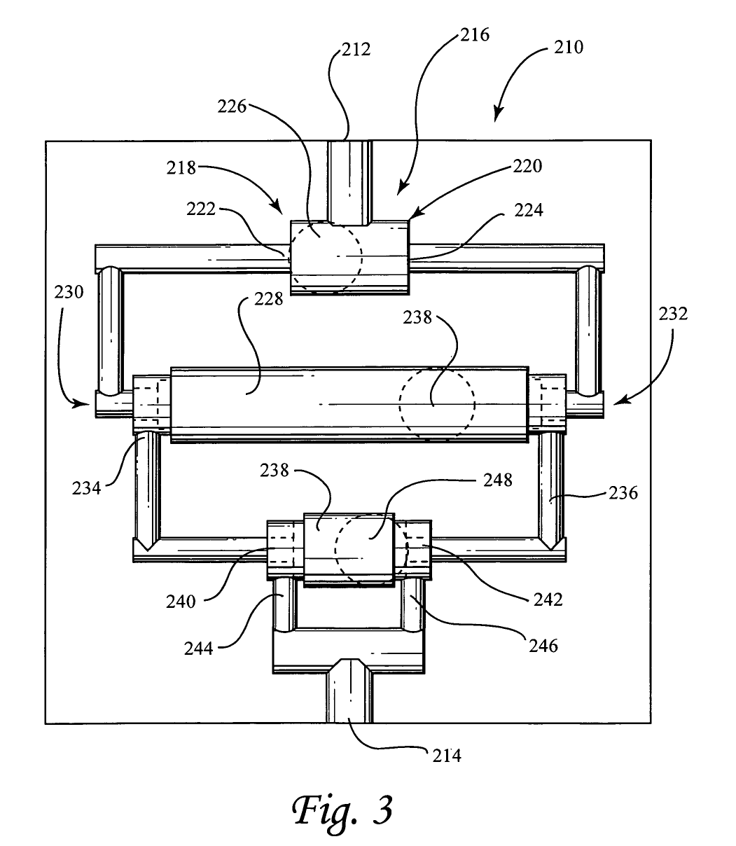

Referring to FIG. 3, a third embodiment of the invention is shown and described, wherein both the measuring chamber and valve chamber have nested ports, and a switching chamber is disposed upstream from the measuring chamber. This embodiment comprises a housing 210, with a fluid inlet 212 and a fluid outlet 214. A switching chamber 216 is connected to the fluid inlet 212 and comprises a first end 218 and a second end 220; a first outlet 222 associated with the first end 218 and a second outlet 224 associated with the second end 220. A first movable body 226 is located in the switching chamber 216, and is capable of moving between the first end 218 and second end 220 of the switching chamber 216. When the movable body 226 is disposed at the first end 218 of the switching chamber 216, the first outlet 222 is blocked, and when the movable body 226 is disposed at the second end 220 of the switching chamber 216, the second outlet 224 is blocked.

A measuring chamber 228 having a first end 230 connected to the first outlet 222 of the switching chamber 216, and a second end 232 connected to the second outlet 224 of the switching chamber 216 is located downstream from the switching chamber 216. The measuring chamber 228 also has a first fluid outlet 234 located at the first end 230 of the measuring chamber 228, and a second fluid outlet 236 located at the second end 232 of the measuring chamber 228.

A movable measuring body 238 is located within the measuring chamber 228, and can move between the first end 230 and second end 232 of the measuring chamber 228. When the movable measuring body 238 is disposed at the first end 230 of the measuring chamber 228, it blocks the first fluid outlet 234 of the measuring chamber 228, and when the movable measuring body 238 is disposed at the second end 232 of the measuring chamber 228, it blocks the second fluid outlet 236 of the measuring chamber 228.

The first end 230 and second end 232 of the measuring chamber 228 comprise inlet and outlet ports, wherein the inlet and outlet ports are configured to provide a decreased cross-sectional area at the contact point of the movable measuring body 238 and the inlet and outlet ports. Due to this configuration, particulates, including maximum sized particulates within the flow stream are directed to either the upstream or downstream side of the contact point of the inlet and outlet ports and movable measuring body 238, or are divided by the striking action of the movable measuring body 238 against the contact points of the movable measuring body 238 and inlet and outlet ports.

In addition to the decreased cross-sectional area, the contact point of the movable measuring body 238 and inlet and outlet ports can comprise a generally sharpened profile at the contact points of the inlet and outlet ports, and the movable measuring body 238 strikes the inlet and outlet ports at the apex of the sharpened profile.

Still referring to FIG. 3, the inlet and outlet ports of the measuring chamber 228 further comprise nested inlet and outlet ports, in the sense that the ports are constructed so that the outlet port is ring shaped and surrounds the inlet port, and wherein the outlet port has a larger opening area than the inlet port so that when the moveable measuring body 238 covers the inlet port and outlet port, the force exerted upon the moveable measuring body 238 by the downstream pressure from the outlet port is sufficient to hold the moveable measuring body 238 in position against the upstream pressure from the inlet port.

Downstream from the measuring chamber 228, a valve chamber 238 has a first inlet 240 connected to the first outlet 234 of the measuring chamber 228, and a second inlet 242 connected to the second outlet 236 of the measuring chamber 228. The valve chamber 238 also has a first outlet 244 associated with the first inlet 240 and connected to the fluid outlet 214, and a second outlet 246 associated with the second inlet 242 and connected to the fluid outlet 214.

A movable valve body 248 is located within the valve chamber 238, movable between a first position that simultaneously seals the first inlet 240 and outlet 244 of the valve chamber 238 and a second position that simultaneously seals the second inlet 242 and outlet 246 of the valve chamber 238.

The inlets 240 and 242, and outlets 244 and 246 of the valve chamber 238 also comprise ports configured to provide a decreased cross-sectional area at the contact point of the movable valve body 248 and the inlet and outlet ports. Due to this configuration, particulates, including maximum sized particulates within the flow stream, are directed to either the upstream or downstream side of the contact point of the inlet and outlet ports and movable valve body 248, or are divided by the striking action of the movable valve body 248 against the inlet and outlet ports.

In another embodiment, the contact point of the inlet and outlet ports and movable valve body 248 comprise a generally sharpened profile at the contact point, wherein the movable valve body strikes the inlet and outlet ports at the apex of the sharpened profile.

Still referring to FIG. 3, each inlet and outlet port further comprises nested inlet and outlet ports; the ports are constructed so that the outlet port is ring shaped and surrounds the inlet port, which is recessed in the outlet port, and wherein the outlet port has a larger opening area than the inlet port, so that when the moveable valve body 248 covers the inlet port and outlet port, the force exerted upon the moveable valve body 248 by the downstream pressure from the outlet port is sufficient to hold the moveable valve body in position against the upstream pressure from the inlet port.

In one preferred embodiment, the outlet 234 of the first end 230 of the measuring chamber 228 is connected to the first position inlet port 240 of the valve chamber 238 through a channel disposed in a wall of the outlet port of the first end 230 of the measuring chamber 228, and the outlet 236 of the second end 232 of the measuring chamber 228 is connected to the second position inlet port 242 of the valve chamber 238 through a channel disposed in a wall of the outlet port of the second end 232 of the measuring chamber 228

In another embodiment, an inlet port connecting the first outlet 222 of the switching chamber 216 to the first end 230 of the measuring chamber 228 is disposed through the ring of the outlet port of the first end 230 of the measuring chamber 228, and an inlet port connecting the second outlet 224 of the switching chamber 216 to the second end 232 of the measuring chamber 228 is disposed through the ring of the outlet port of the second end 232 of the measuring chamber 228.

In yet another embodiment, the outlet 244 of the first position of the valve chamber 238 is connected to the fluid outlet 214 through a channel disposed in a wall of the outlet port of the first position of the valve chamber 238, and the outlet 246 of the second position of the valve chamber 238 is connected to the fluid outlet 214 through a channel disposed in a wall of the outlet port of the second position of the valve chamber 238. In this embodiment the inlet port connecting the first outlet 234 of the measuring chamber 228 to the first position of the valve chamber 238 is disposed through the ring of the outlet port of the first position of the valve chamber 238, and an inlet port 242 connecting the second outlet 236 of the measuring chamber 228 to the second position of the valve chamber 238 is disposed through the ring of the outlet port of the second position of the valve chamber 238.

As fluid moves through the sensor, when the movable valve body 248 in the valve chamber 238 seals the first inlet 240 and outlet 244 in the first position, fluid flowing through the sensor urges the movable measuring body 238 in the measuring chamber 228 from the first end 230 of the measuring chamber 228 to the second end 232 of the measuring chamber 228. When the movable measuring body 238 reaches the second end 232 of the measuring chamber 228, it cuts off the flow of fluid through the second outlet 236 of the measuring chamber 228, diverting the fluid through the first outlet 234 of the measuring chamber 228, and pushing the movable valve body 248 in the valve chamber 238 into the second position.

When the movable valve body 248 reaches the second position, it seals the second fluid inlet 242 and outlet 246 of the valve chamber 238, and causes fluid flowing through the sensor to urge the movable measuring body 238 from the second end 232 of the measuring chamber 228 back to the first end 230 of the measuring chamber 228 where it blocks the first outlet 234 of the measuring chamber 228, diverting fluid through the second outlet 236 of the measuring chamber 228 and causing the movable valve body 248 in the valve chamber 238 to switch back to the first position to seal the first inlet 240 and first outlet 244 of the valve chamber 238, and cause the fluid flowing through the sensor to urge the movable measuring body 238 toward the second end 232 of the measuring chamber 228, repeating the process.

In addition, when the first movable body 226 in the switching chamber 216 is in the first end 218 of the switching chamber 216 blocking the first outlet 222 of the switching chamber 216, the movable measuring body 238 moves from the second end 232 of the measuring chamber 228 toward the first end 230 of the measuring chamber 228. Once the movable measuring body 226 blocks the flow of fluid through the first outlet 222 of the switching chamber 216, fluid pressure causes the first movable body 226 to move to the second end 220 of the switching chamber 216.

When the movable measuring body 238 moves to the second end 232 of the measuring chamber 228 and blocks the second fluid outlet 224 of the switching chamber 216, the first movable body 226 is urged back to the first end 18 of the switching chamber 216, repeating the process. In this manner the movement of the first movable body 226, movable measuring body 238 and movable valve body 248 are synchronized.

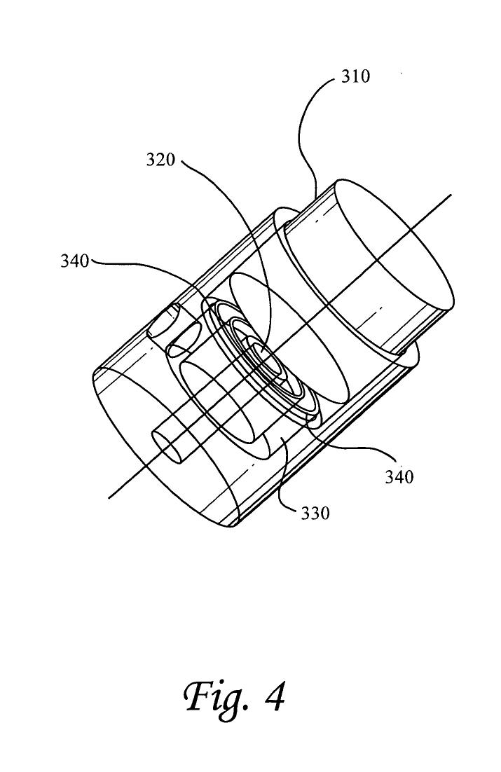

Referring to FIG. 4, an alternate embodiment of the nested inlet and outlet ports and corresponding movable body is shown and described, wherein the movable body 310 is a cylinder, and the inlet 320 and outlet 330 ports conform to the ends of the cylinder 310. In this embodiment, each side of the measuring chamber comprises an inlet port and outlet port, further comprising nested inlet and outlet ports, wherein the nested ports are constructed so that the outlet port is ring shaped and surrounds the inlet port, and wherein the outlet port has a larger opening area than the inlet port, so that when the moveable measuring body covers the inlet port and outlet port, the force exerted upon the moveable measuring body by the downstream pressure from the outlet port is sufficient to hold the moveable body in position against the upstream pressure from the inlet port.

In one embodiment, the openings to the outlet port and inlet port are flush to conform to a flat surface. In a further embodiment, the edges of the openings of the outlet port and inlet port comprise raised generally sharpened areas 340 so that particulates, including maximum sized particulates within the flow stream are directed to either the upstream or downstream side of the contact point of the inlet and outlet ports and movable measuring body, or are divided by the striking action of the movable measuring body against the apex of the sharpened areas.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. § 112, paragraph 6. In particular, the use of “step of” in the claims herein is not intended to invoke the provisions of 35 U.S.C. § 112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A fluid flow sensor for measuring the volumetric flow of a fluid, comprising
a. a housing 10 having a fluid inlet 12 and a fluid outlet 14;
b. an inlet valve means 16 for alternately directing a continuous flow of fluid from the fluid inlet 12 to a first outlet 22 or second outlet 24 in the inlet valve means 16, connected to the fluid inlet 12;
c. a measuring chamber 26 having a first end 28 connected to the first outlet 22 of the inlet valve means 16, and a second end 30 connected to the second outlet 24 of the inlet valve means 16, and also having a first measuring chamber outlet 32 at the first end 28 of the measuring chamber 26, and a second measuring chamber outlet 34 at the second end 30 of the measuring chamber 26;
d. a movable measuring body 38 within the measuring chamber 26, movable between the first end 28 and second end 30 of the measuring chamber 26;
e. a movable valve body 20 within the inlet valve means 16, movable between a first position in which the first outlet 22 of the inlet valve means 16 is closed and the second outlet 24 of the inlet valve means 16 is open, wherein fluid flow into the second end 30 of the measuring chamber 26 urges the movable measuring body 38 toward the first end 28 of the measuring chamber 26, and wherein the movable valve body 20 is held in the first position solely by combined upstream pressure at the fluid inlet 12 and downstream pressure at the first outlet 32 of the measuring chamber 26; and a second position in which the second outlet 24 of the inlet valve means 16 is closed and the first outlet 22 of the inlet valve means 16 is open, wherein fluid flow into the first end 28 of the measuring chamber 26 urges the movable measuring body 38 toward the second end 30 of the measuring chamber 26, and wherein the movable valve body 20 is held in the second position solely by combined upstream pressure at the fluid inlet 12 and downstream pressure at the second outlet 34 of the measuring chamber 26;
f. wherein when the movable measuring body 38 reaches the first end 28 of the measuring chamber 26, it simultaneously closes the connection to the first outlet 22 of the inlet valve means 16 and first outlet 32 of the measuring chamber 26, and when the measuring body reaches the second end 30 of the measuring chamber 26, it simultaneously closes the connection to the second outlet 24 of the inlet valve means 16 and second outlet 34 of the measuring chamber 26.

2. The sensor of claim 1, wherein the first and second ends of the measuring chamber comprise inlet and outlet ports, wherein the inlet and outlet ports are configured to provide a decreased cross-sectional area at the contact point of the movable measuring body and the inlet and outlet ports, and wherein particulates, including maximum sized particulates within the flow stream are directed to either the upstream or downstream side of the contact point of the sides of the inlet and outlet ports and movable measuring body or are divided by the striking action of the movable measuring body against the inlet and outlet ports.

3. The sensor of claim 2, wherein the decreased cross-sectional area comprises a generally sharpened profile at the sides of the inlet and outlet ports and wherein the movable measuring body strikes the inlet and outlet ports at the apex of the sharpened profile.

4. The sensor of claim 1, wherein each end of the measuring chamber further comprises nested inlet and outlet ports, wherein the nested ports are constructed so that the outlet port is ring shaped and surrounds the inlet port, and wherein the outlet port has a larger opening area than the inlet port, so that when the moveable measuring body covers the inlet port and outlet port, the force exerted upon the moveable measuring body by the downstream pressure from the outlet port is sufficient to hold the moveable body in position against the upstream pressure from the inlet port.

5. The sensor of claim 4, wherein each outlet port of the measuring chamber is connected to the fluid outlet through a channel disposed in a wall of the outlet port, and wherein the inlet port is connected to the measuring chamber by a channel disposed through the ring of the outlet port.

6. The sensor of claim 1, wherein the movable measuring body is a cylinder.

7. The sensor of claim 6, wherein each side of the measuring chamber comprises an inlet port and outlet port, further comprising nested inlet and outlet ports, wherein the nested ports are constructed so that the outlet port is ring shaped and surrounds the inlet port, wherein the outlet port is disposed so as to surround the inlet port, wherein the outlet port has a larger opening area than the inlet port, so that when the moveable measuring body covers the inlet port and outlet port, the force exerted upon the moveable measuring body by the downstream pressure from the outlet port is sufficient to hold the moveable body in position against the upstream pressure from the inlet port, and wherein the contact points of the movable measuring body and inlet and outlet ports comprise raised generally sharpened areas so that particulates, including maximum sized particulates within the flow stream are directed to either the upstream or downstream side of the contact point of the sides of the inlet and outlet ports and movable measuring body, or are divided by the striking action of the movable measuring body against the sharpened areas.

8. A fluid flow sensor for measuring the volumetric flow of a fluid, comprising
a. a housing 10 having a fluid inlet 12 and a fluid outlet 14;
b. a measuring chamber 16 having a first end 18 and a second end 20, each separately connected to the fluid inlet 12, and also having a first fluid outlet 22 located at the first end 18, and a second fluid outlet 24 located at the second end 20;
c. a movable measuring body 26 within the measuring chamber 16, movable between the first end 18 and second end 20 of the measuring chamber 16; wherein when the movable measuring body 26 is positioned at the first end 18 of the measuring chamber 16, it blocks the first fluid outlet 22 of the measuring chamber 16 and connection to the fluid inlet 12, and when the movable measuring body 26 is positioned at the second end 20 of the measuring chamber 16, it blocks the second fluid outlet 24 of the measuring chamber 16 and connection to the fluid inlet 12;
d. a valve chamber 28 with a first inlet 30 connected to the first outlet 22 of the measuring chamber 16, and a second inlet 32 connected to the second outlet 24 of the measuring chamber 16; a first outlet 34 associated with the first inlet 30 and connected to the fluid outlet 14, and a second outlet 36 associated with the second inlet 32 and connected to the fluid outlet 14;
e. a movable valve body 38 within the valve chamber 28 movable between a first position that seals the first inlet 30 and first outlet 34 of the valve chamber 28, and a second position that seals the second inlet 32 and second outlet 36 of the valve chamber 28;
f. Wherein when the movable valve body 38 in the valve chamber 28 seals the first fluid inlet 30 and first fluid outlet 34 in the first position, fluid flowing through the sensor urges the movable measuring body 26 in the measuring chamber 16 from the first end 18 of the measuring chamber 16 to the second end 20 of the measuring chamber 16 where it cuts off the flow of fluid through the second outlet 24 of the measuring chamber 16, diverting the fluid through the first outlet 22 of the measuring chamber 16, and pushing the movable valve body 38 in the valve chamber 28 into the second position, sealing the second fluid inlet 32 and second fluid outlet 36 of the valve chamber 28, and causing fluid flowing through the sensor to urge the movable measuring body 26 from the second end 20 of the measuring chamber 16 back to the first end 18 of the measuring chamber 16 where it will block the first outlet 22 of the measuring chamber 16, diverting fluid through the second outlet 24 of the measuring chamber 16 and causing the movable valve body 38 of the valve chamber 28 to switch back to the first position to seal the first fluid inlet 30 and first fluid outlet 34 of the valve chamber 20, and cause the fluid flowing through the sensor to urge the movable measuring body 26 toward the second end 20 of the measuring chamber 16, repeating the process.

9. The sensor of claim 8, wherein the first inlet and outlet and second inlet and outlet of the valve chamber comprise ports configured to provide a decreased cross-sectional area at the point of contact between the movable body and the sides of the inlet and outlet ports, and wherein particulates, including maximum sized particulates within the flow stream are directed to either the upstream or downstream side of the point of contact, or are divided by the striking action of the movable body against the ports.

10. The sensor of claim 9, wherein the decreased cross-sectional area comprises a generally sharpened profile at the inlet and outlet ports, and wherein the movable measuring body strikes the inlet and outlet ports at the apex of the sharpened profile.

11. The sensor of claim 8, wherein each end of the valve chamber further comprises nested inlet and outlet ports, wherein the nested ports are constructed so that the outlet port is ring shaped and surrounds the inlet port, wherein the outlet port is disposed so as to surround the inlet port, and wherein the outlet port has a larger opening area than the inlet port, so that when the moveable body covers the inlet port and outlet port, the force exerted upon the moveable body by the downstream pressure from the outlet port is sufficient to hold the moveable body in position against the upstream pressure from the inlet port.

12. The sensor of claim 11, wherein the outlet ports are connected to the fluid outlet through channel disposed in the wall of the outlet ports, and wherein each inlet port is connected to the valve chamber by a channel disposed through the ring of its associated outlet port.

13. The sensor of claim 8, wherein the movable body is a cylinder.

14. The sensor of claim 13, wherein each side of the valve chamber comprises an inlet port and outlet port, further comprising nested inlet and outlet ports, wherein the nested ports are constructed so that the outlet port is ring shaped and surrounds the inlet port, and wherein the outlet port has a larger opening area than the inlet port, so that when the moveable body covers the inlet port and outlet port, the force exerted upon the moveable body by the downstream pressure from the outlet port is sufficient to hold the moveable body in position against the upstream pressure from the inlet port, and wherein the edges of the inlet and outlet ports comprise raised generally sharpened areas so that particulates, including maximum sized particulates within the flow stream are directed to either the upstream or downstream side of the contact point of the sides of the inlet and outlet ports and movable measuring body, or are divided by the striking action of the movable measuring body against the sharpened areas.

15. A fluid flow sensor for measuring the volumetric flow of a fluid, comprising
a. a housing 10 having a fluid inlet 12 and a fluid outlet 14;
b. a switching chamber 16 connected to the fluid inlet 12, having a first end 18 and a second end 20; a first outlet 22 associated with the first end 18 and a second outlet 24 associated with the second end 20;
c. a first movable body 26 in the switching chamber 16, movable between the first end 18 and second end 20 of the switching chamber 16; wherein when the movable body 26 is disposed at the first end 18 of the switching chamber 16, the first outlet 22 is blocked, and when the movable body 26 is disposed at the second end 20 of the switching chamber 16, the second outlet 24 is blocked;
d. a measuring chamber 28 having a first end 30 connected to the first outlet 22 of the switching chamber 16, and a second end 32 connected to the second outlet 24 of the switching chamber 16; and also having a first fluid outlet 34 located at the first end 30 of the measuring chamber 28, and a second fluid outlet 36 located at the second end 32 of the measuring chamber 28;
e. a movable measuring body 38 within the measuring chamber 28, movable between the first end 30 and second end 32 of the measuring chamber 28; wherein when the movable measuring body 38 is disposed at the first end 30 of the measuring chamber 28, it blocks the first fluid outlet 34 of the measuring chamber 28, and when the movable measuring body 38 is disposed at the second end 32 of the measuring chamber 28, it blocks the second fluid outlet 36 of the measuring chamber 28;
f. a valve chamber 38 with a first inlet 40 connected to the first outlet 34 of the measuring chamber 28, and a second inlet 42 connected to the second outlet 36 of the measuring chamber 28; a first outlet 44 associated with the first inlet 40 and connected to the fluid outlet 14, and a second outlet 46 associated with the second inlet 42 and connected to the fluid outlet 14;
e. a movable valve body 48 within the valve chamber 38 movable between a first position that seals the first inlet 40 and outlet 44 of the valve chamber 38 and a second position that seals the second inlet 42 and outlet 46 of the valve chamber 38;
f. Wherein when the movable valve body 48 in the valve chamber 38 seals the first inlet 40 and outlet 44 in the first position, fluid flowing through the sensor urges the movable measuring body 38 in the measuring chamber 28 from the first end 30 of the measuring chamber 28 to the second end 32 of the measuring chamber 28 where it cuts off the flow of fluid through the second outlet 36 of the measuring chamber 28, diverting the fluid through the first outlet 34 of the measuring chamber 28, and pushing the movable valve body 48 in the valve chamber 38 into the second position, sealing the second fluid inlet 42 and outlet 46 of the valve chamber 38, and causing fluid flowing through the sensor to urge the movable measuring body 38 from the second end 32 of the measuring chamber 28 back to the first end 30 of the measuring chamber 28 where it will block the first outlet 34 of the measuring chamber 28, diverting fluid through the second outlet 36 of the measuring chamber 28 and causing the movable valve body 48 in the valve chamber 38 to switch back to the first position to seal the first inlet 40 and first outlet 44 of the valve chamber 38, and cause the fluid flowing through the sensor to urge the movable measuring body 38 toward the second end 32 of the measuring chamber 28, repeating the process; and
g. wherein the first movable body 26 in the switching chamber 16 is in the first end 18 of the switching chamber 16 blocking the first outlet 22 of the switching chamber 16 as the movable measuring body 38 moves from the second end 32 of the measuring chamber 28 toward the first end 30 of the measuring chamber 28, and is urged to the second end 20 of the switching chamber 16 once the movable measuring body 26 blocks the flow of fluid through the first outlet 22 of the switching chamber 16; and wherein when the movable measuring body 38 moves to the second end 32 of the measuring chamber 28 and blocks the second fluid outlet 24 of the switching chamber 16, the first movable body 26 is urged back to the first end 18 of the switching chamber 16, repeating the process in tandem with the movable measuring body 38.

16. The sensor of claim 15, wherein the first and second ends of the measuring chamber comprise inlet and outlet ports, wherein the inlet and outlet ports are configured to provide a decreased cross-sectional area at the contact point of the movable measuring body and sides of the inlet and outlet ports, and wherein particulates, including maximum sized particulates within the flow stream are directed to either the upstream or downstream side of the contact point of the sides of the inlet and outlet ports and movable measuring body, or divided by the striking action of the movable measuring body against the inlet and outlet ports.

17. The sensor of claim 15, wherein the inlet and outlet ports at the first and second positions of the movable valve body in the valve chamber are configured to provide a decreased cross-sectional area at the contact point of the movable body and sides of the inlet and outlet ports, and wherein particulates, including maximum sized particulates within the flow stream are directed to either the upstream or downstream side of the contact point of the sides of the inlet and outlet ports and movable valve body in the valve chamber, or divided by the striking action of the movable valve body against the inlet and outlet ports.

18. The sensor of claim 16, wherein the decreased cross-sectional area comprises a generally sharpened profile at the sides of the inlet and outlet ports and wherein the movable measuring body strikes the inlet and outlet ports at the apex of the sharpened profile.

19. The sensor of claim 17, wherein the decreased cross-sectional area comprises a generally sharpened profile at the sides of the inlet and outlet ports and wherein the movable valve body strikes the inlet and outlet ports at the apex of the sharpened profile.

20. The sensor of claim 15, wherein each end of the measuring chamber further comprises nested inlet and outlet ports, wherein the nested ports are constructed so that the outlet port is ring shaped and surrounds the inlet port, wherein the outlet port is disposed so as to surround the inlet port, and wherein the outlet port has a larger opening area than the inlet port, so that when the moveable measuring body covers the inlet port and outlet port, the force exerted upon the moveable measuring body by the downstream pressure from the outlet port is sufficient to hold the moveable body in position against the upstream pressure from the inlet port.

21. The sensor of claim 15, wherein each end of the valve chamber further comprises nested inlet and outlet ports, wherein the nested ports are constructed so that the outlet port is ring shaped and surrounds the inlet port, wherein the outlet port is disposed so as to surround the inlet port, and wherein the outlet port has a larger opening area than the inlet port, so that when the moveable valve body covers the inlet port and outlet port, the force exerted upon the moveable valve body by the downstream pressure from the outlet port is sufficient to hold the moveable valve body in position against the upstream pressure from the inlet port.

22. The sensor of claim, wherein the outlet port of the first end of the measuring chamber is connected to the first position inlet port of the valve chamber through a channel disposed in a wall of the outlet port of the first end of the measuring chamber, and the outlet port of the second end of the measuring chamber is connected to the second position inlet port of the valve chamber through a channel disposed in a wall of the outlet port of the second end of the measuring chamber; and wherein an inlet port connecting the first outlet port of the switching chamber to the first end of the measuring chamber is disposed through the ring of the outlet port of the first end of the measuring chamber, and an inlet port connecting the second outlet port of the switching chamber to the second end of the measuring chamber is disposed through the ring of the outlet port of the second end of the measuring chamber.

23. The sensor of claim, wherein the outlet port of the first position of the valve chamber is connected to the fluid outlet through a channel disposed in a wall of the outlet port of the first position of the valve chamber, and the outlet port of the second position of the valve chamber is connected to the fluid outlet through a channel disposed in a wall of the outlet port of the second position of the valve chamber; and wherein an inlet port connecting the first outlet port of the measuring chamber to the first position of the valve chamber is disposed through the ring of the outlet port of the first position of the valve chamber, and an inlet port connecting the second outlet port of the measuring chamber to the second position of the valve chamber is disposed through the ring of the outlet port of the second position of the valve chamber.

24. The sensor of claim 15, wherein the movable measuring body in the measuring chamber is a cylinder.

25. The sensor of claim 15, wherein the movable body in the valve chamber is a cylinder.

26. The sensor of claim 24, wherein each side of the measuring chamber comprises an inlet port and outlet port, further comprising nested inlet and outlet ports, wherein the nested ports are constructed so that the outlet port is ring shaped and surrounds the inlet port, wherein the outlet port is disposed so as to surround the inlet port, wherein the outlet port has a larger opening area than the inlet port, so that when the moveable measuring body covers the inlet port and outlet port, the force exerted upon the moveable measuring body by the downstream pressure from the outlet port is sufficient to hold the moveable body in position against the upstream pressure from the inlet port, and wherein the edges of the inlet and outlet ports comprise raised generally sharpened areas so that particulates, including maximum sized particulates within the flow stream are directed to either the upstream or downstream side of the contact point of the sides of the inlet and outlet ports and movable measuring body, or are divided by the striking action of the movable measuring body against the sharpened areas.

27. The sensor of claim 25, wherein each side of the valve chamber comprises an inlet port and outlet port, further comprising nested inlet and outlet ports, wherein the nested ports are constructed so that the outlet port is ring shaped and surrounds the inlet port, wherein the outlet port is disposed so as to surround the inlet port, wherein the outlet port has a larger opening area than the inlet port, so that when the moveable body covers the inlet port and outlet port, the force exerted upon the moveable body by the downstream pressure from the outlet port is sufficient to hold the moveable body in position against the upstream pressure from the inlet port, and wherein the edges of the inlet and outlet ports comprise raised generally sharpened areas so that particulates, including maximum sized particulates within the flow stream are directed to either the upstream or downstream side of the contact point of the sides of the inlet and outlet ports and movable body, or are divided by the striking action of the movable body against the sharpened areas.
